(19) United States
(12) Patent Application Publication
(10) Pub. No.: US 2014/0086309 A1
(43) Pub. Date: Mar. 27, 2014

(54) METHOD AND DEVICE FOR ENCODING AND DECODING AN IMAGE

(71) Applicant: FREESCALE SEMICONDUCTOR, INC., Austin, TX (US)

(72) Inventors: Shlomo Beer-Gingold, Guivat Shmuel (IL); Ofer Naaman, Hod-Hasharon (IL); Michael Zarubinsky, Hertzelia (IL)

(73) Assignee: Freescale Semiconductor, Inc., Austin, TX (US)

(21) Appl. No.: 14/119,372

(22) PCT Filed: Jun. 16, 2011
(86) PCT No.: PCT/IB2011/052624

§ 371 Date: Nov. 21, 2013

(51) Int. Cl. H04N 7/26

(52) U.S. Cl. CPC H04N 19/00484; H04N 19/00012; H04N 19/00072
USPC 375/240.02; 375/240.24

(57) ABSTRACT

A method for encoding an image. The method comprises: dividing the image into a plurality of variable sized blocks, encoding each sub-block using variable bit rate encoding, storing the encoded sub-blocks, generating a marker matrix, and storing the marker matrix for use in decoding the image.

### FIELD OF THE INVENTION

This invention relates to image encoding and decoding methods and devices in general, and to image encoding and decoding methods and devices using a compressed frame buffer in particular.

### BACKGROUND OF THE INVENTION

In recent years, the demand for high resolution video in TVs, computers and other devices capable of providing video has been increasing, and this demand is now also being felt in the portable devices market. As comparatively high definition screens have become more common among modern portable multimedia devices such as tablets, PCs and smart phones, high resolution video quality has become a key competitive differentiating factor.

With improved video quality comes smoother video, improved colour, fewer artefacts from resizing, compression or other image processing, and various other benefits. These improve the user experience in ways that go beyond a mere increase in the visible detail.

The most advanced video processing algorithms, such as motion compensated frame rate conversion or 3D-video processing, require multiple reads/writes of each video frame data from/to the external system memory. For high-resolution video on a portable multimedia device, and particularly high quality high-resolution video, the total memory access load can easily become unacceptably high.

In order to reduce load on the memory system, frame buffer compression is used. However, this approach has several drawbacks.

For example, advanced video processing algorithms often require random access to the frame buffer. The most widely used compression methods are based on sequential compression or decompression, so random access to frame segments cannot be achieved without decoding the whole frame or a large frame section.

One method which allows random access is the use of constant bit rate (CBR) encoding in the compressed stream. As the resulting compression is constant, the location of required data within a compressed dataset can be calculated easily. However CBR encoding provides a worse rate of compression than other methods since, for example, it does not allow for adaptation within a frame to account for video content. This leads to a decrease in performance of the system.

### SUMMARY OF THE INVENTION

The present invention provides a method and device for encoding images as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows an example of a multimedia device;

FIG. 2 is a flow diagram of an example video handling method using external memory;

FIG. 3 is a flow diagram of an example encoding method;

FIG. 4 illustrates an example of a process for dividing an image;

FIG. 5 is an example map of the memory inside a compressed frame buffer;

FIG. 6 shows an example marker matrix and encoding block offset table;

FIG. 7 is a further flow diagram of an example video handling method using internal and external memory;

FIG. 8 illustrates an example of a process for storing encoded information;

FIG. 9 shows an example image that may be encoded;

FIG. 10 shows two different example methods for dividing an image according to detail level;

FIG. 11 shows an example decision making process for choosing how to divide an image;

FIG. 12 is a chart showing example ratio thresholds which may be used in the decision making process of FIG. 11;

FIG. 13 is a flow diagram of an example of a decoding method; and

FIGS. 14 and 15 illustrate examples of how two images may be superposed in a sequential access decompression and in a random access decompression.

### DETAILED DESCRIPTION OF THE PREFERRED EMBODIMENTS

Because the illustrated embodiments of the present invention may for the most part be implemented using electronic components and circuits known to those skilled in the art, details will not be explained in any greater extent than that considered necessary as illustrated, for the understanding and appreciation of the underlying concepts of the present invention and in order not to obfuscate or distract from the teachings of the present invention.

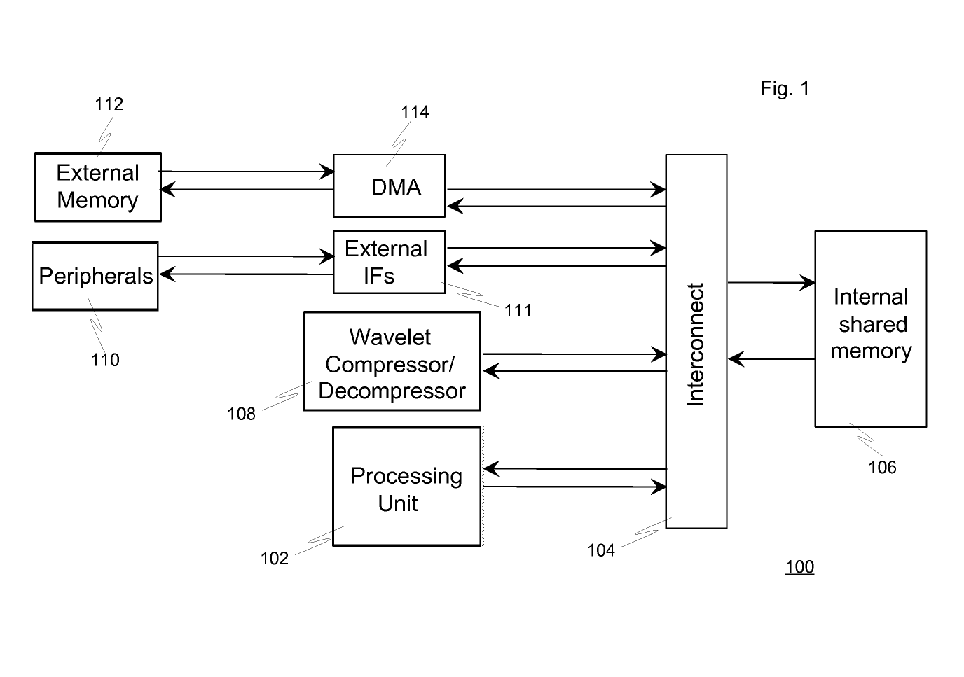

FIG. 1 schematically shows an example of a multimedia device 100, including a processing unit 102, connected to an interconnect 104. The interconnect 104 provides connections between the components of the multimedia device 100, including an internal shared memory 106, a wavelet compressor/decompressor 108 and peripherals 110 connected through external interfaces 111. The interconnect 104 may comprise any suitable interconnect technology or standard and the invention is not limited in this respect. The interconnect 104 may also provide connections to an external memory 112, for example via a Direct Memory Access (DMA) module 114.

The wavelet compressor/decompressor 108 may be arranged to carry out wavelet transforms, for example on images, and compressing the resulting transform(s) for storage. The wavelet compressor/decompressor 108 may also be arranged to decompress one or more transforms and carry out further wavelet transforms to restore the compressed data, for example an image.

The peripherals 110 may comprise video devices such as cameras for capturing images, or video playback devices providing pre-captured video image data, or display devices such as screens and projectors for displaying images. The peripherals 110 may also comprise further software for producing or using images, such as codecs.

Other multimedia devices with other layouts may be used with methods according to the invention. For example, a multimedia device may have multiple processing units, or may use other forms of compression instead of wavelet type compression. In such cases, the wavelet Compressor/Decompressor may be replaced with a Compressor/Decompressor arranged to carry out the type of transforms or compression/decompression types used for the compression standard chosen. The invention is not limited to any particular type of compression standard.

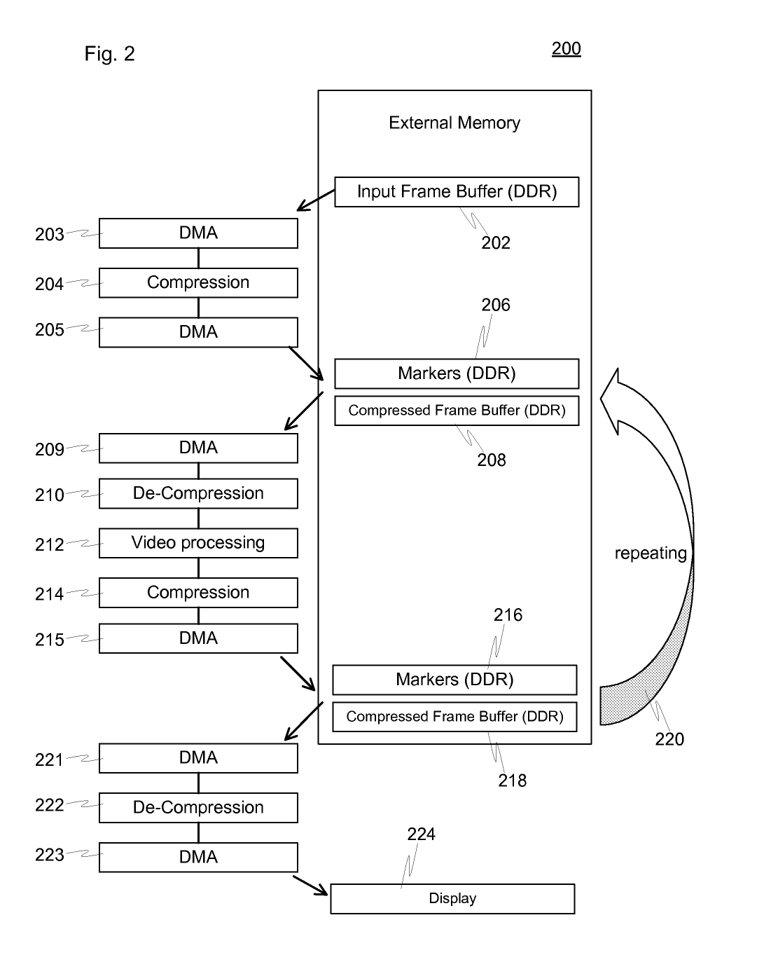

FIG. 2 illustrates a video handling method 200 which may be used by the multimedia device 100. Firstly, the multimedia device 100 retrieves 202 an input frame to be compressed from an input frame buffer in the external memory 112. The input frame is delivered 203 to the processing unit 102 and the wavelet compressor/decompressor 108 by the DMA module 114 to be compressed 204. The compression process then produces a marker matrix and a compressed frame (to be described in more detail below). The marker matrix and compressed frame are delivered 205 by the DMA module 114 to a markers buffer 206 and a compressed frame buffer 208 in the external memory 112.

To carry out further processing on the compressed frame, which may be carried out on the decompressed frame, the marker matrix and the compressed frame may be both delivered 209 by the DMA module 114 to the wavelet compressor/decompressor 108 and the processing unit 102 for decompression 210, and then passed for the further video processing 212 in uncompressed form using any suitable video processing algorithm. Due to the use of a marker matrix, it is not necessary for the entire compressed frame buffer to be accessed and/or decompressed during this method, and it may be that only a part of the compressed frame buffer is decompressed and processed instead. Having been decompressed and processed, the frame buffer may be recompressed 214 and delivered 215 by the DMA module 114 to the external memory 112 and the markers buffer 216 and compressed frame buffer 218.

This processing method may be repeated 220 as many times as required by the video processing technique in use, for example motion compensated frame rate conversion or 3D processing techniques, since most video processing algorithms need to read the same image data several times. As explained above, since the frames in high definition video are large, processing the frames on-the-fly would consume a lot of memory bandwidth resources. Using a compressed frame stored in a compressed frame buffer, and transferring the frame or parts of the frame in a compressed format, and processing the image in several stages using a marker matrix reduces the memory bandwidth resources required to handle the image.

Once any further processing is complete, the compressed frame buffer and the marker matrix may be delivered 221 by the DMA module 114 to the wavelet compressor/decompressor 108 and the processing unit 102 to be decompressed 222. This provides an uncompressed output frame which may then be delivered 223 to a display unit for display 224.

The video handling method shown in FIG. 2 may ensure that the data sent to and received from the external memory during processing is typically in a compressed format, thereby reducing memory bandwidth usage

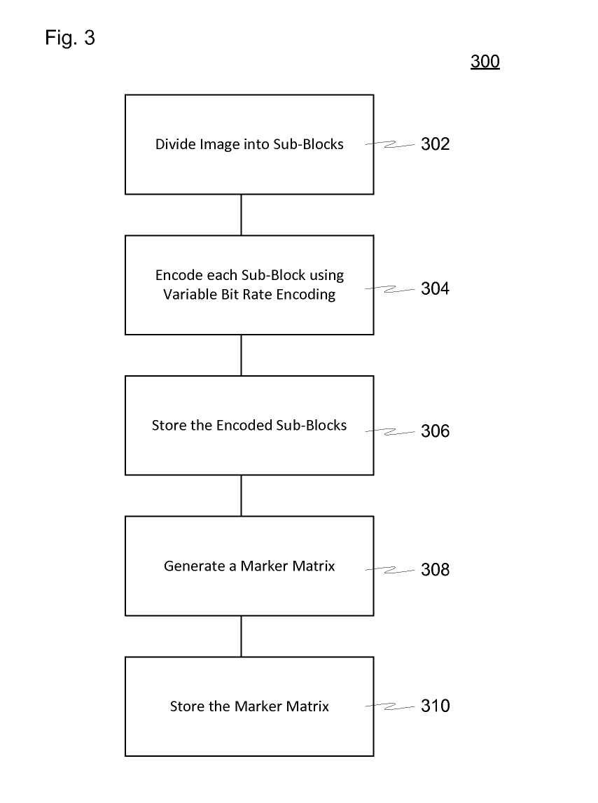

FIG. 3 illustrates a method for encoding an image 300 which could be used in the compression method 204, 214 illustrated in FIG. 2. This method may be carried out by multimedia device 100 as illustrated in FIG. 1. The method 300 comprises dividing the image into a plurality of sub-blocks 302, encoding each sub-block 304 using a suitable Variable Bit Rate (VBR) encoding method, storing the VBR encoded sub-blocks 306 in a memory, generating a marker matrix 308 for the VBR encoded sub-blocks, and storing the marker matrix for use in subsequent decoding of the encoded image 310.

The particular order of this method may be changed so that, for example, the marker matrix may be generated 308 before the encoded sub-blocks are stored 306. The different parts of the method may also be carried out concurrently where hardware allows (e.g. multi-core, or having multiple compression/decompression hardware instances).

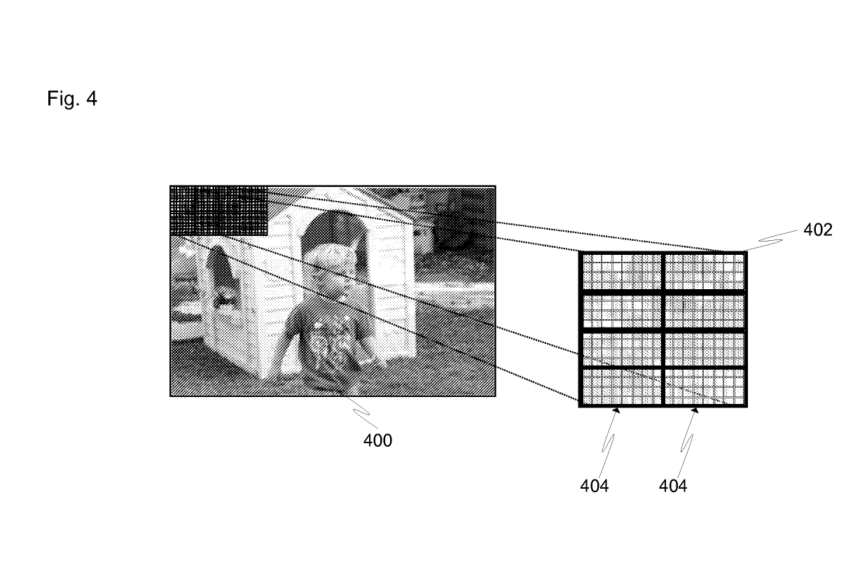

FIG. 4 illustrates one way to divide the image into a plurality of sub-blocks 302. A first image 400 may be divided into a plurality of regularly sized task blocks 402, where each regularly sized task block 402 is then divided into a plurality of sub-blocks 404. The invention is not limited in any way to the choice of size of task block 402 and sub-block 404 used, which may be dependent on the desired output quality of the video, and the characteristics of the input video (such as level of detail, and the like), as will be explained in more detail below

Having been divided up, the sub-blocks 404 may then be encoded using a variable bit rate encoding method, so that there is variation in the number of bits required to store each encoded sub-block 404.

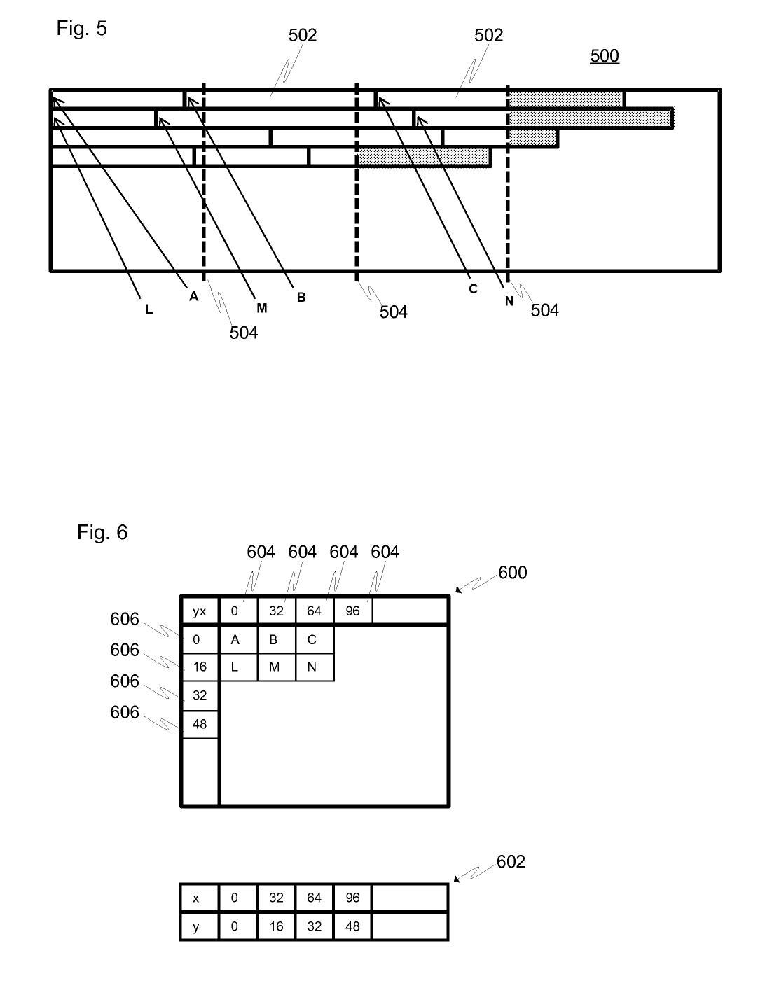

FIG. 5 is an example map 500 of the memory inside a compressed frame buffer intended to illustrate the variability in the size of encoded sub-blocks 502. The dotted lines 504 show the boundaries of an exemplary optimal burst read/write block size for the particular memory architecture in use (i.e. the best size of read/write “chunks” of data to ensure optimal memory access speeds and the like) and how these do not map onto the variable sized encoded sub-blocks 502. In the example shown in FIG. 5, in order to access all the VBR encoded block shown, a total of fifteen memory accesses may be used, comprising eleven full memory read bursts (clear portions), and four partial memory read bursts (shaded portions).

FIG. 6 illustrates a marker matrix 600 and an encoding block offset table 602. The marker matrix 600 is as generated in the method illustrated in FIG. 3. In the multimedia device 100, the marker matrix 600 and the encoding block offset table 602 may both be generated by the compressor 108 during encoding. The marker matrix 600 comprises a record of the position of each encoded sub-block 502. In the example shown in FIG. 6, the marker matrix 600 comprises the starting position of each encoded sub-block 502, but the marker matrix could alternatively store any predetermined set point within the encoded sub-block 502, for example the ending position of each encoded sub-block 502.

In FIG. 6 the starting position of each encoded sub-block is represented by the letters A, B, C, L, M, N. Not all positions are shown in this example. The location of these starting positions is also indicated in FIG. 5 using arrows. In the example shown the starting position is in the form of a memory address, given in bit resolution. Alternatively, the starting position may be in the form of an offset vector, which is a given number of bits from a predetermined starting position such as the start of a compressed frame buffer. The location of a starting position within the matrix may be related to the position of the sub-block within the image 400 or the task block 402. In the example given, the x coordinate 604 and the y coordinate 606 of the first pixel in each sub-block are given along the edges of the marker matrix 600. Therefore item A is the starting position of the encoded sub-block 502 which represents the 32 by 16 pixel rectangle with a first pixel at coordinates (0,0) in the task block 402, where coordinate (0,0) is in the top left corner of the image. Similarly, M is the starting position of the encoded sub-block which represents the 32 by 16 pixel rectangle with a first pixel at coordinates (32,16) in the task block 402.

In the example given in FIG. 6, the sub-blocks are regularly sized, 32 pixels wide by 16 pixels high. These fixed size increments are indicated along the top and the left hand side of the marker matrix 600. However, the sub-blocks 502 do not need to be of regular size. Where an implementation uses sub-blocks 502 that change in size over the course of the image (for example, when dealing with an image with areas of high detail, and areas of low detail) then this variation in the size of the sub-blocks may be recorded in the marker matrix, using suitably valued x coordinates 604 and y coordinates 606.

In some examples of the invention, the x and y coordinates 604, 606 may be stored separately from the marker matrix, as an encoding block offset table 602. The encoding block offset table 602 may be comparatively small. In the example given in FIG. 6, the encoding block offset table 602 may be compressed easily, as the intervals are regular and may be expressed as a simple formula. However, the encoding block offset table 602 may be as large as or larger than the marker matrix itself, for example where the sub-blocks are of many different sizes or shapes, and in such a situation an offset table 602 may be used to record this.

The encoded sub-blocks 502 may be stored in memory (external or internal shared memory) in a contiguous or non-contiguous arrangement, according to the needs of the multimedia device 100. An encoding method as described herein offers inherent support for a non-contiguous frame buffer since, if the encoded sub-blocks 502 are stored in a non contiguous arrangement, then the marker matrix 600 will reflect this in the changed values of A, B, C and so on. Non-contiguous arrangements may be helpful in achieving memory optimisation, by utilising unused memory locations located between used memory locations that might otherwise be overlooked in a contiguous only implementation.

In the example described above, the sub-blocks 404 are rectangular. However, the sub-blocks 404 can be shapes other than rectangles. Any tessellating shape, or combination of shapes, may be used. The shapes used may be chosen to suit the needs of the encoding or compression techniques that are to be deployed.

The use of a marker matrix 600 with pixel coordinates for memory accesses as described above may allow for the use of variable bit rate (VBR) compression, whilst also allowing ready localised access to the image data (i.e. direct access to a specified portion of the overall image). This is because the marker matrix may allow access to a particular pixel location, or group thereof, without having to start from the beginning of the whole image. Once the image to be encoded is divided up into sub-blocks, each block may be individually encoded using VBR, or any other suitable compression technique. Compression in a multimedia device 100 would be handled by the processing unit 102 and the wavelet compressor/decompressor 108 as described above.

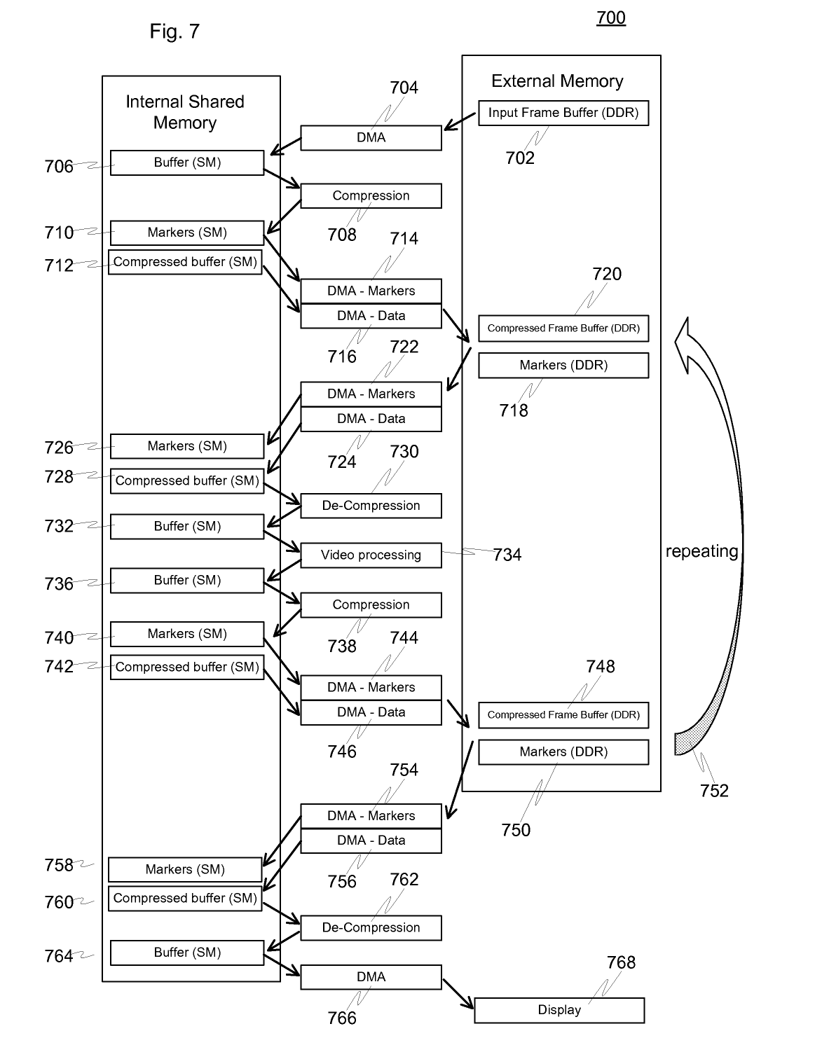

The multimedia device 100 may use a plurality of buffers, located in different memories, during video processing, for example, using main external memory as well as a shared memory (SM) (for example an internal shared memory). FIG. 7 shows a video handling method 700 according to an example of the invention, in which an internal shared memory 106 (SM) and the external shared memory 112 are both used. The method is substantially the same as the one shown in FIG. 2, except that communication between the DMA module 114 and processing unit 102 and wavelet compressor/decompressor 108 is done via caches in the internal shared memory 106.

Firstly, the multimedia device 100 retrieves 702 an input frame from an input frame buffer in the external memory 112. In the example shown, the input frame is delivered 704 to a buffer 706 in the internal shared memory 106 and subsequently compressed 708 by the processing unit 102 and the wavelet compressor/decompressor 108. The compression process produces a marker matrix 600 and a compressed frame, which are stored in a markers buffer 710 and a compressed buffer 712 in the internal shared memory 106, respectively. The marker matrix 600 and the compressed frame may then be delivered 714, 716 by the DMA module 114 to a markers buffer 718 and a compressed frame buffer 720 in the external memory 112.

To carry out further processing on the compressed frame, the marker matrix 600 and at least a part of the compressed frame may be both delivered 722, 724 by the DMA module 114 to the markers buffer 726 and the compressed buffer 728 in the internal shared memory 106, where they may be decompressed 730 by the wavelet compressor/decompressor 108 and the processing unit 102 and stored in a buffer 732 in the internal shared memory 106. The uncompressed data may then be put through further video processing 734 in uncompressed form using any suitable video processing algorithm before being stored in a buffer 736 ready for compression 738 and storage in the markers buffer 740 and the compressed buffer 742 in the internal shared memory 106 again.

Having been processed, the contents of the markers buffer 740 and the compressed buffer 742 are delivered 744, 746 by the DMA module 114 to the external memory 112 and the markers buffer 748 and compressed frame buffer 750. This part of the method may be repeated 752 as many times as required by the video processing technique used.

Once processing is complete, the compressed frame buffer and the marker matrix are delivered 754, 756 by the DMA module 114 to the markers buffer 758 and the compressed buffer 760 in the internal shared memory 106 for decompression 762 by the wavelet compressor/decompressor 108 and the processing unit 102 and storage in a buffer 764. This provides an output frame which can be delivered 766 to a display 768.

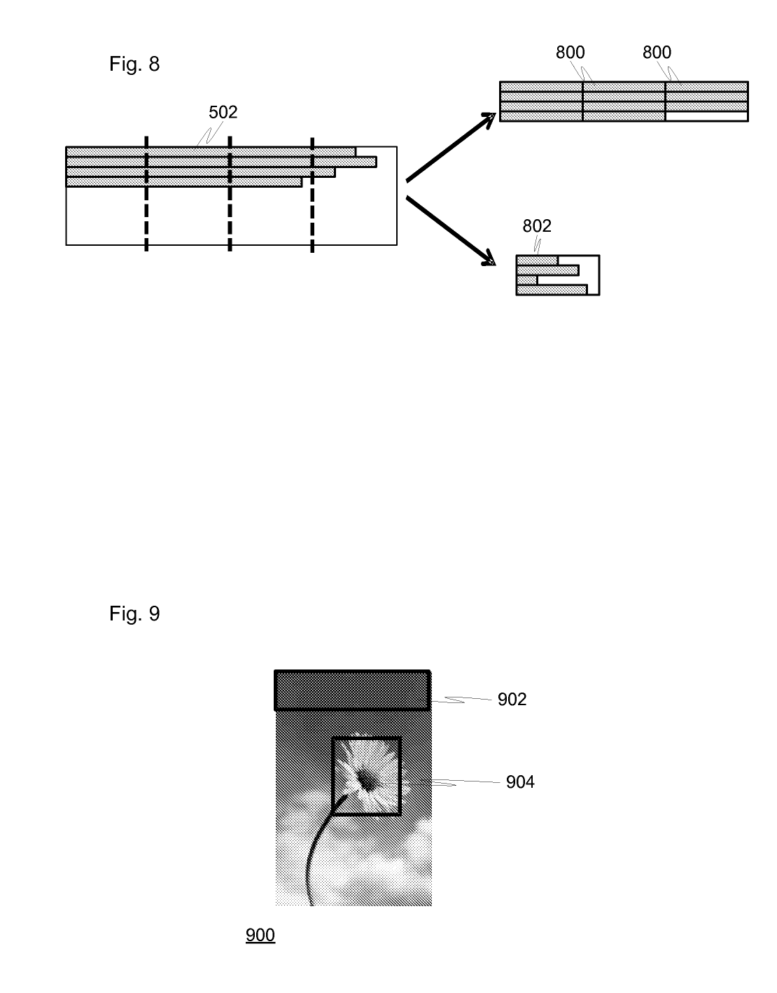

In some examples that may achieve optimised memory accesses, when the encoded sub-blocks 502 are stored 306, they may be stored in a plurality of buffers. FIG. 8 is a diagram which illustrates such an example using a plurality of buffers. The encoded sub-blocks 502 may be stored in at least one full burst size buffer 800 and at least one residual buffer 802. A multimedia device 100 may typically use a plurality of full burst size buffers 800 and a plurality of residual buffers 802. The full burst size buffers 800 may be of a predetermined size and the residual buffers 802 may comprise those parts of the encoded sub-blocks 502 which are not part of a full burst size buffer 800.

To achieve good utilization of the bandwidth available for communicating with the external memory 112 through the DMA module 114, the read/write bursts for each memory access may have constant and maximal length. Turning back to FIG. 5 momentarily, the dotted lines 504 illustrates how the VBR encoded sub-blocks 502 may not line up with the optimal fixed burst size read/write accesses to the memory architecture in use, and how the data may be accessed using a number of full and partial burst memory accesses. However, FIG. 8 shows how the use of full and partial memory accesses may be optimised by using additional shared memory (typically internal) to provide improved performance.

At least one full burst size buffer 800 and at least one residual buffer 802 may be located within a first memory such as (internal) shared memory 106. The contents of the full burst size buffer 800 may then be sent to a second memory such as the external memory 112, with the contents of the residual buffer being left in the internal shared memory, where it may be combined with later memory accesses to form further complete burst read accesses.

Where this is done, the predetermined size of the full burst size buffer 800 may be determined by the bandwidth parameters of the second memory. In this way, a method or device using the herein described method(s) to handle video may provide optimal burst accesses according to the type of memory used. The burst size may be determined in part or entirely by the transmission characteristics of the DMA module 114, providing a plurality of full burst sized buffers 800 which may be of a size ideally suited for efficient communication with the external memory 112.

The contents of a residual buffer 802 may be combined with further encoded sub-blocks 502 in order to fill a full burst size buffer 800. The further encoded sub-blocks 502 may be at least part of the contents of a further residual buffer 802. The resulting full burst size buffer 800 may in turn also be sent to the second memory if required.

Depending upon the relative size of the full burst size buffers 800 and the encoded sub-blocks 502, a full burst size buffer may contain all or parts of a plurality of encoded sub-blocks 502. Alternatively, an encoded sub-block 502 may be split up across one or more full burst size buffers 800 and a residual buffer 802.

When handling video, marker matrices 600 may also be compressed before they are stored as illustrated in FIG. 3. Marker matrices 600 may be stored in full burst size and residual buffers 800, 802, and sent to a second memory in the same fashion as the encoded sub-blocks 502, if required. Alternatively, marker matrices 600 may be kept only in the first memory. The marker matrices 600 may be handled separately from the encoded sub-blocks 502 (for example being stored in separate buffers), or the marker matrices 600 and the encoded sub-blocks 502 may be handled together, for example being stored in the same buffers.

Similarly, an encoding block offset table 602 may be compressed and stored according to the methods set out above, either with a marker matrix 600, with other encoding block offset tables, or on its own.

Video frames and other images may differ in their statistical content (e.g. due to variance in the level of detail across an image), both from image to image and within the same image. FIG. 9 shows a second image 900 with areas of low detail 902 and areas of high detail 904. For the purposes of encoding the image, the areas of high detail typically occur at edges shown within the image, while areas of low detail typically occur in backgrounds. Because of these variations, achieving maximal compression may depend in part on image content.

The size of the sub-blocks in a method according to examples of the invention may be adjusted according to the statistics of the image and the video to improve performance. In such an example, the sub-blocks 404 may be content adaptive, based on both the inter-frame and intra-frame statistics of the video.

For example, larger block sizes may be used in smooth, low detail areas so that the overall compression performance may be improved by the use of, for example, run length encoding codes. Smaller block sizes will typically be used in high detail areas.

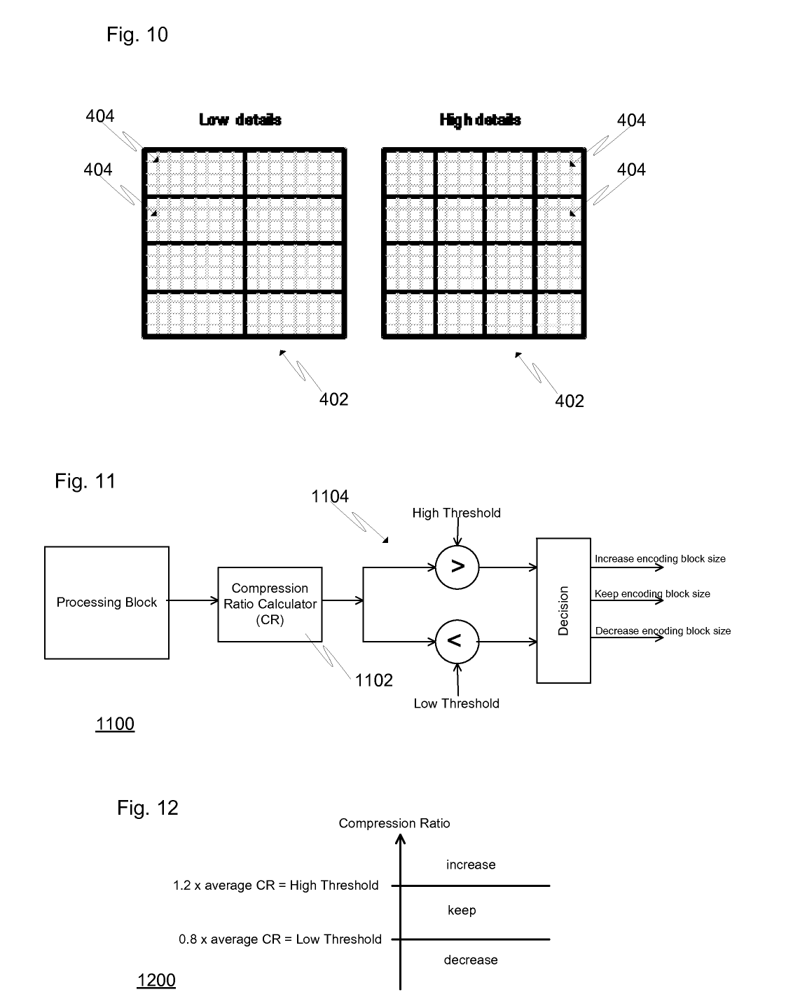

FIG. 10 shows how a task block 402 may be divided up into sub-blocks 404 in two different ways, according to the level of detail in the image being encoded by the task block. For an image with low detail, the sub-blocks 404 may be comparatively large (e.g. 8 by 4 pixel rectangles). Whereas, for an image with high detail, the sub-blocks 404 may be comparatively small (e.g. 4 by 4 pixel squares). The size of the sub-blocks 404 may then be stored in the marker matrix 600 or an encoding block offsets table 602 as described above.

Similarly, sub-block sizes may be chosen based on the statistics of neighbouring frames of video. For example the statistics of a previous frame may be used to determine the sub-block sizes of the next frame.

FIG. 11 illustrates a decision making process 1100 that may be used by the multimedia device 100 to determine sub-block sizes. In this decision making process 1100 the multimedia device 100 may calculate the compression ratio of each sub-block 404 in the previous frame 1102. The compression ratio of each sub-block 404 may then be compared to the average compression ratio 1104.

Information on compression ratios achieved in the previous frames buffers typically indicate the degree of detail present in that frame, and due to the nature of video (e.g. lots of similar images in succession, with only portions changing between frames, unless, for example a cut transition occurs) may indicate the likely situation in a (closely) following frame. Therefore, if the compression ratio of a given sub-block 404 is high, then the multimedia device 100 may use a larger sub-block 404 in the same location in the next frame. Whereas, if the compression ratio of a given sub-block 404 is low, then the multimedia device 100 may use a smaller sub-block 404 in the same location in the next frame. Where there are several sub-blocks 404 with high compression ratios gathered together, the multimedia device 100 may remove some of them all together and increase the size of the remaining sub-blocks 404. Conversely, where there are several sub-blocks 404 with low compression ratios gathered together, the multimedia device 100 may decrease their size and add new sub-blocks.

FIG. 12 is a chart 1200 showing example ratio thresholds that may be used in the decision making process shown in FIG. 11. In this example, if the compression ratio is more than 1.2 times the average compression ratio, then sub-block size is increased, and if the compression ratio is less than 0.8 times the average compression ratio, then sub-block size is decreased. If the compression lies on or between 0.8 and 1.2 times the average compression ratio, then the sub-block size is kept constant.

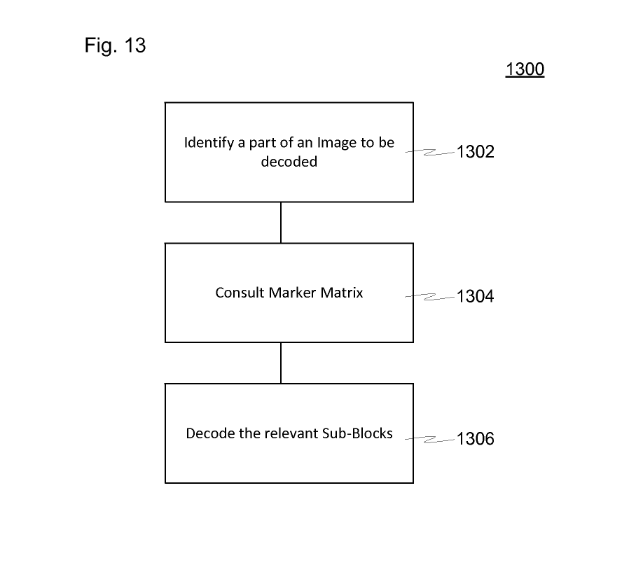

FIG. 13 is a flow chart illustrating a method for decoding an image 1300 which has been encoded as illustrated in FIG. 3, for example as part of the methods shown in FIGS. 2 and 7. The method includes: identifying at least a part of the image to be decoded 1302, consulting the marker matrix to determine a position of the encoded sub-blocks which comprise the part of the image to be decoded 1304; and decoding those blocks 1306.

The marker matrix may also be consulted to determine which of the sub-blocks comprise the part of the image to be decoded. Alternatively, an encoding block offset table 602 may be consulted, where one exists.

So, for example, in order for the multimedia device 100 to retrieve a 64 by 64 pixel block starting at coordinates (0,0) in the task block 402 represented by the marker matrix 600 shown in FIG. 6, the DMA module 114 reads from address A (position 0,0) to address C (position 0,64) by calculating C-A in burst resolution to get the number of bursts required from the compressed frame buffer. The DMA module 114 then reads from address L (position 16,0) to address N (position 16, 64), and so on until the whole 64 by 64 block is read.

The addresses in the marker matrix 600 shown in FIG. 6 are in bit resolution; however the DMA module 114 may use burst resolution to access the external memory 122. Therefore the DMA module 114 may often read more data in from the external memory 112 than is immediately required. This extra data typically comprises all or part of at least one extra encoded sub-block 502. Where this happens, the extra data may be saved, for example in the internal shared memory 106. This may be a useful strategy, since many video processing algorithms access sections of an image sequentially. Therefore, where the encoded sub-blocks 502 are stored in a contiguous manner, the extra data already read into the internal memory may frequently be needed shortly afterwards.

So, for example, if the multimedia device next wants to retrieve a 64 by 64 pixel block starting at coordinates (64,0) in the task block 402 represented by the marker matrix 600 shown in FIG. 6, it will know that, in the process of retrieving the encoded sub-block starting at position B, it has already retrieved most of the encoded sub-block starting at position C. This can be seen in FIG. 5, where the two encoded sub-blocks 502 share a full burst size frame buffer 800. Therefore there is no need to retrieve this information again.

Even when the blocks are stored in a non-contiguous manner, the manner may be chosen to maximise the occasions on which the extra data already read into the internal shared memory 106 is needed shortly afterwards, and so decrease the number of accesses of the external memory 112.

Consulting the marker matrix 600 as illustrated at 1304 in FIG. 13 may involve retrieving the marker matrix from the external memory 112, and then decoding the marker matrix. Decoding the relevant blocks 1306 typically requires the encoded sub-blocks to be retrieved from the external memory 112 and possibly also the internal shared memory 106.

Using a decoding method as illustrated n FIG. 8, the marker matrix 600 generated in the encoding phase is used in the decoding phase to allow random access to data. The use of a marker matrix 600 allows random access to the compressed frame buffer, which may mean that a block inside a frame may be read without reading all the previous blocks, i.e. unneeded encoded sub-blocks 502 may not have to be retrieved and decoded before the needed ones, and this saves time and memory bandwidth resources. The overhead of extra-memory read may therefore be minimised by sub-block granularity and this use of the marker matrix 600.

Moreover, there is no need to decompress a whole image or section of an image when two image layers need to be superposed.

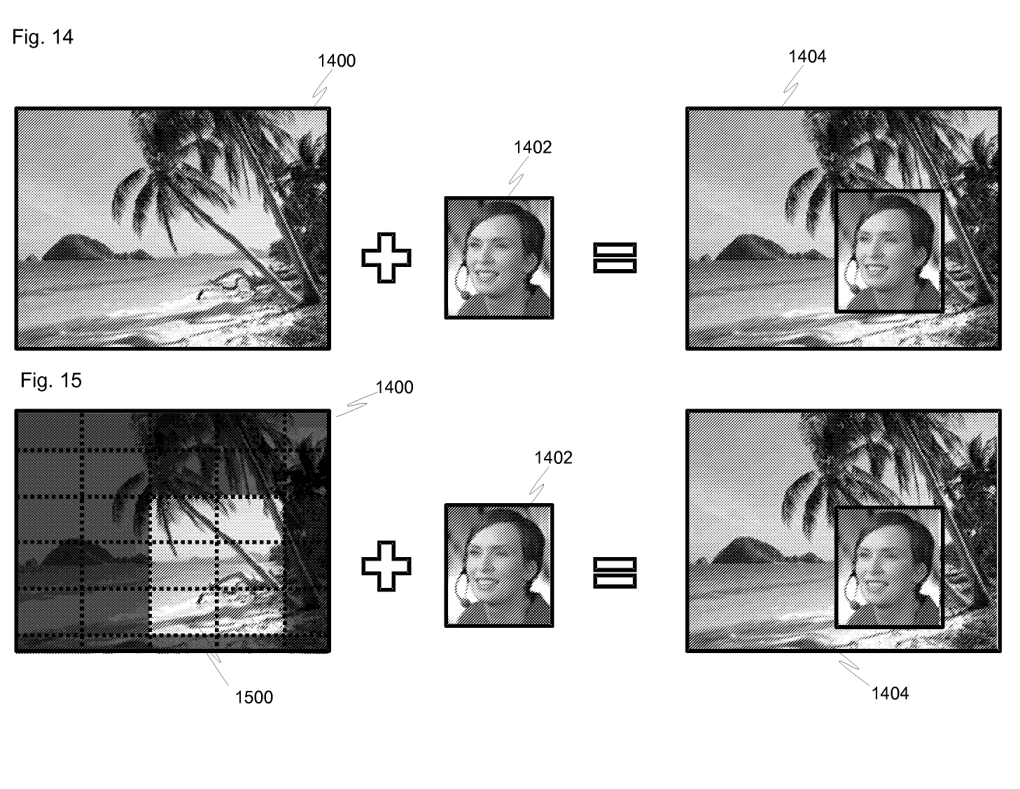

FIGS. 14 and 15 illustrate this point. FIG. 14 shows how a third image 1400 and a fourth image 1402 may be superposed in a sequential access decompression using variable bit rate compression. The third image 1400 is decompressed to create the superposition 1404, but since the third image 1400 was compressed using variable bit rate compression without using a marker matix, the entire third image 1400 must be decompressed, since there is no record of where each VBR encoded sub-block is located in the data stream. FIG. 15 shows how the same two images are superposed using random access decompression according to the invention, using a marker matrix 600. As the fourth image 1402 is smaller than the third image 1400, only a part 1500 of the third image 1400 is decompressed.

Therefore the present invention provides a method and a device for reducing a system memory access load by compressing frame buffers. The proposed solution enables both random access to different portions of the frame buffer, and optimal compression with minimal overhead. It also allows adaptive changes to the compression block size depending on image contents, both intra and inter frame in the case of video, in order to achieve better compression factors.

Hence both high image and video quality and high compression may be achieved in the system described above, without sacrificing random access to the frame buffers.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

The invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

Other modifications of, variations to and alternatives to the examples described above are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method for encoding an image, the method comprising:
receiving an image at a processing unit;
dividing the image into a plurality of sub-blocks;
encoding each sub-block;
storing the encoded sub-blocks in a memory;
generating a marker matrix, the marker matrix comprising a record of a position of each encoded sub-block within the memory; and
storing the marker matrix in a memory, wherein the marker matrix is retrievable for use in decoding the image.

2. A method according to claim 1, wherein at least one sub-block is encoded using variable bit rate encoding.

3. The method according to claim 1, wherein dividing the image into a plurality of sub-blocks comprises:
dividing the image into a plurality of task blocks; and
dividing each task block into a plurality of sub-blocks.

4. The method according to claim 1, further comprising:
storing the encoded sub-blocks in a non-contiguous arrangement.

5. (canceled)

6. (canceled)

7. (canceled)

8. (canceled)

9. (canceled)

10. (canceled)

11. (canceled)

12. (canceled)

13. (canceled)

14. (canceled)

15. A device for encoding an image, the device comprising a processing unit, the processing unit being arranged to:
divide the image into a plurality of sub-blocks;
encode each sub-block;
store the encoded sub-blocks on a memory;
generate a marker matrix, the marker matrix comprising a record of a position of each encoded sub-block within the memory; and
store the marker matrix in a memory, wherein the marker matrix is retrievable for use in decoding the image.

16. The device according to claim 15, wherein the processing unit is arranged to encode at least one sub-block using variable bit rate encoding.

17. The device according to claim 15, wherein the processor is further arranged to:
divide the image into a plurality of task blocks; and
divide each task block into a plurality of sub-blocks.

18. The device according to claim 15, wherein the processing unit is further arranged to:
store the encoded sub-blocks in a non-contiguous arrangement.

19. The device according to claim 15, wherein the marker matrix comprises a starting position of each encoded sub-block.

20. The device according to claim 15, wherein the processing unit is further arranged to store the encoded sub-blocks in a plurality of buffers.

21. The device according to claim 20, wherein the processing unit is further arranged to:
store the encoded sub-blocks in at least one full burst size buffer and at least one residual buffer, wherein the at least one full burst size buffer is of a predetermined size and the at least one residual buffer comprises those parts of the encoded sub-blocks which are not in the at least one full burst size buffer.

22. The device according to claim 21, wherein the at least one full burst size buffer and the at least one residual buffer are located in a first memory.

23. The device according to claim 22, further comprising a second memory, wherein the processing unit is arranged to send a contents of the full burst size buffer to a second memory.

24. The device according to claim 23, wherein the predetermined size of the at least one full burst size buffer is determined by a bandwidth of the second memory.

25. The device according to claim 21, wherein the processing unit is arranged to combine the contents of a residual buffer with further encoded sub-blocks in order to fill the full burst size buffer.

26. The device according to claim 21, wherein a full burst size buffer contains all or parts of a plurality of encoded sub-blocks.

27. The device according to claim 15, wherein the marker matrix comprises a memory address of the starting position of each encoded sub-block, in bit resolution.

28. A device for decoding an image encoded by the device of claim 15, the device comprising a processing unit and at least a first memory, the processing unit being arranged to:
identify at least a part of the image to be decoded;
consult the marker matrix to determine the position of the encoded sub-blocks which comprise the part of the image to be decoded;
retrieve the encoded sub-blocks which comprise the part of the image to be decoded from a memory; and
decode the encoded sub-blocks.

29. A device according to claim 15, the device comprising a first memory external to the processing unit and a second memory internal to the processing unit.

30. An article comprising a computer readable storage medium having instructions stored thereon that, when executed by a computing platform, operate to carry out the method of claim 1.
